(19) United States
(12) Patent Application Publication
(10) Pub. No.: US 2013/0095866 A1
(43) Pub. Date: Apr. 18, 2013

(54) METHOD AND TERMINAL FOR PROCESSING SHORT MESSAGE

(71) Applicants: Cuihong Yang, Shenzhen (CN); Xiaogang Pei, Shenzhen (CN)

(72) Inventors: Cuihong Yang, Shenzhen (CN); Xiaogang Pei, Shenzhen (CN)

(21) Appl. No.: 13/704,946

(22) PCT Filed: Oct. 15, 2010
(86) PCT No.: PCT/CN2010/077801

§ 371 Date: Dec. 17, 2012

(30) Foreign Application Priority Data
Jun. 18, 2010 (CN) 201010203750.0

(51) Int. Cl. H04W 4/12

(52) U.S. Cl. CPC H04W 4/12
USPC 455/466

(57) ABSTRACT

The disclosure discloses a method and terminal for processing short message, comprising: receiving a short message, and creating an index identifier corresponding to the short message; storing the index identifier to a preset index file; storing the short message to a preset message file according to the index identifier. The method performs processes to short message in storage space of mobile terminal according to actual data length of short message, and stores as many short messages as possible in limited storage space, thereby efficiently utilizing storage space of SIM card used in mobile terminal, improving utilization ratio of storage space, saving resources, and providing convenience for manufactures and users of mobile terminal. Furthermore, the method can be compatible with existing SIM cards and mobile terminals, and enables existing SIM cards and mobile terminals to perform processes to short message using 6F3C file structure as usual.

### FIELD OF THE INVENTION

The disclosure relates to the field of mobile communication, and in particular to a method and a terminal for processing short message in an intelligent subscriber identity card.

### BACKGROUND OF THE INVENTION

At present, with the development of mobile communication technology, the short message service has become a popularized service ranked second in frequency of use of all mobile communication services, because of the low expense and convenience in communication. Many value-added services, such as weather forecast and information delivery, of operators are increasingly introduced by taking the advantages of short message.

Therefore, the importance of the function and method of storing the short message to the mobile terminal is self-evident. The memory of mobile terminal itself can store short message. Nonetheless, because a Subscriber Identity Module (SIM) card has the unique feature of being replaceable and pluggable, users prefer to store short message in the SIM card.

According to requirement of the GSM11.11 specification, the structure of the 6F3C file of the currently used SIM cards, which is used for storing short message, is the linear fixed-length file. It means that the record length of each short message of the 6F3C file is fixed. However, in practice, data lengths of short messages are different. If space is reserved for each short message according to a fixed length, then the actually reserved space cannot be fully utilized because of different data length of each short message, thereby reducing the number of short messages actually stored in limited storage space, and inevitably wasting resources.

### SUMMARY OF THE INVENTION

The disclosure mainly provides a method and a terminal for processing short message, for improving short message storage capacity of the intelligent subscriber identity card, such as the SIM card in mobile terminal to save resources.

According to an aspect of the disclosure, a method for processing short message is provided, comprising steps of:

receiving a short message, and creating an index identifier corresponding to the short message;

storing the index identifier in a preset index file; and

storing the short message in a preset message file according to the index identifier.

Furthermore, the index identifier comprises: the index identifier comprises: an index number, an index storage address corresponding to the index number and a data length of a short message corresponding to the index number.

Furthermore, creating the index identifier corresponding to the short message comprises:

searching the index file;

obtaining an index number of the short message and an index storage address of the short message according to the index file; and

obtaining a data length of the short message.

Furthermore, obtaining the index number of the short message and the index storage address of the short message according to the index file comprises:

adding an index number sequentially after a previous index number in the index file to obtain the index number of the short message; and

adding a data length of a short message corresponding to the previous index number to an index storage address corresponding to the previous index number to obtain the index storage address of the short message.

Furthermore, storing the short message in the preset message file according to the index identifier comprises:

searching the message file;

shifting forward in the message file by the index storage address of the short message in the index identifier; and

storing the short message in the message file according to the index storage address of the short message.

Furthermore, after storing the short message in the preset message file according to the index identifier, the method further comprises:

searching, according to an index number of a short message to be deleted, for a corresponding index storage address and a corresponding data length of the short message in the index file;

deleting, in the message file, bytes of the corresponding data length of the short message at the corresponding index storage address; and

deleting the corresponding index storage address and the corresponding data length of the short message in the index file.

Furthermore, after deleting the corresponding index storage address and the corresponding data length of the short message in the index file, the method further comprises:

after the short message to be deleted is deleted, shifting an address of a short message after the deleted short message backward by the data length of the deleted short message;

shifting backward the index number of the deleted short message in the index file.

According to another aspect of the disclosure, a terminal for processing short message is provided, which comprises:

a receiving module, configured to receive a short message;

a creating module, configured to create an index identifier corresponding to the short message; and

a storing module, configured to store the index identifier in a preset index file, and store the short message in a preset message file according to the index identifier.

Furthermore, the creating module comprises:

a first searching unit, configured to search the index file; and

an obtaining unit, configured to obtain an index number of the short message and an index storage address of the short message according to the index file, and obtain a data length of the short message.

Furthermore, the obtaining unit comprises:

an index number obtaining subunit, configured to sequentially add an index number after a previous index number in the index file to obtain the index number of the short message; and

an index storage address obtaining subunit, configured to add a data length of a short message corresponding to the previous index number to an index storage address corresponding to the previous index number to obtain the index storage address of the short message.

Furthermore, the storing module comprises:

a second searching unit, configured to search the message file;

an shifting subunit, configured to shift forward in the message file by the index storage address of the short message in the index identifier; and

a storing subunit, configured to store the short message in the message file according to the index storage address of the short message.

Furthermore, the terminal further comprises:

a searching module, configured to search, according to an index number of a short message to be deleted, for a corresponding index storage address and a corresponding data length of the short message in the index file; and

a deleting module, configured to delete, in the message file, bytes of the corresponding data length of the short message at the corresponding index storage address, and delete the corresponding index storage address and the corresponding data length of the short message in the index file.

Furthermore, the shifting subunit is further configured to, after the short message to be deleted is deleted, shift an address of a short message after the deleted short message backward by the data length of the deleted short message, and shift backward the index number of the deleted short message in the index file.

The method and terminal for processing short message of the disclosure store the short message in storage space of mobile terminal according to the actual data length of the short message, and delete the short message from storage space of mobile terminal according to the actual data length of the short message. Thereby, the disclosure can store as many short messages as possible in the limited storage space. The disclosure improves the utilization ratio of the storage space of mobile terminal, saves resources, and provides convenience for manufactures and users of mobile terminal.

### BRIEF DESCRIPTION OF THE DRAWINGS

The drawings described herein are used for providing a further understanding of the disclosure, and constitute a part of the application. The schematic embodiments of the disclosure and the description thereof are used for illustrating the disclosure and are not intended to form improper limit to the disclosure. In the drawings:

FIG. 1 shows a flowchart of an embodiment of a method for processing short message of the disclosure;

FIG. 2 shows a specific flowchart of the process of creating the index identifier corresponding to the short message in the method for processing short message shown in FIG. 1;

FIG. 3 shows a specific flowchart of the process of obtaining the index number of the short message and the index storage address of the short message according to the index file in the method for processing short message shown in FIG. 2;

FIG. 4 shows a specific flowchart of the process of storing the short message in the preset message file according to the index identifier in the method for processing short message shown in FIG. 1;

FIG. 5 shows a flowchart of another embodiment of the method for processing short message of the disclosure;

FIG. 6 shows a structure diagram of an embodiment of the terminal for processing short message of the disclosure;

FIG. 7 shows a specific structure diagram of the creating module of the terminal for processing short message shown in FIG. 6;

FIG. 8 shows a specific structure diagram of the obtaining unit in the creating module of the terminal for processing short message shown in FIG. 7;

FIG. 9 shows a specific structure diagram of the storing module of the terminal for processing short message shown in FIG. 6; and

FIG. 10 shows a structure diagram of another embodiment of the terminal for processing short message of the disclosure.

### DETAILED DESCRIPTION OF THE EMBODIMENTS

It should be noted that the embodiments and features in the embodiments in the application can be combined with each other if not conflicting. The disclosure is described hereinafter in detail with reference to the drawings and embodiments.

In the related art, the short messages are stored in the file 6F3C in the directory 7F10 of the SIM card, wherein the file is named EFSMS, the file identifier is 6F3C, and the file structure is of the linear fixed-length type. The length of each record of the short message is 176 bytes, the storage limit of records is 255, and each short message occupies one record length fixedly. If a short message only has a length of 60 bytes, then the short message wastes space of 176-60=16 bytes. If all the records are added up, more space is wasted. When the last one is to be stored, it is possible that it may not be stored, even there is space left.

The solution of embodiments of the disclosure is mainly: in mobile terminal, storing the received short message according to the actual data length of the short message, so as to improve the utilization ratio of storage space of the mobile terminal.

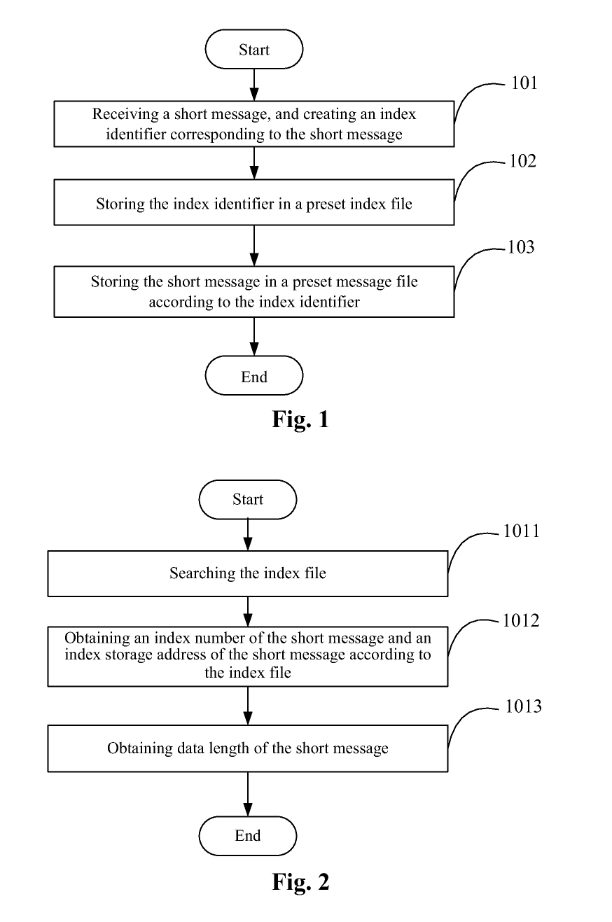

As shown in FIG. 1, an embodiment of the disclosure provides a method for processing short message, which comprises:

Step 101: receiving the short message, and creating the index identifier corresponding to the short message;

Step 102: storing the index identifier in the preset index file; and

Step 103: storing the short message in the preset message file according to index identifier.

In the embodiment, the SIM card is taken as the example. When the mobile terminal stores the short message through the SIM card, first the message file for storing the short message is created in the SIM card, and the index file for storing the index identifier corresponding to the short message is created, wherein the index identifier comprises: the index number of the short message, the index storage address corresponding to the index number and the data length of the short message corresponding to the index number. That is to say, the index identifiers corresponding to different short messages are stored in the index file.

When a new short message is to be stored in the SIM card, first an index number is obtained by sequentially adding an index number after the previous index number, and then the data length of the short message corresponding to the previous index number is added in the index storage address corresponding to the previous index number in the index file to obtain the index storage address corresponding to this index number. At the same time, the data length of the new short message is recorded in the index file. Then, according to the calculated index storage address of the new short message, it shifts in the message file to this index storage address, and the data content of the short message is stored at the index storage address. In this case, in the SIM card, an initial index storage address is assigned to the index file by a SIM card processor, then a shifting amount of address is calculated according to the length occupied by each short message data. Each short message is correspondingly stored in the message file.

Preferably, as shown in FIG. 2, creating the index identifier corresponding to the short message in step 101 can further comprise:

Step 1011: searching the index file;

Step 1012: obtaining the index number of the short message and the index storage address of the short message according to the index file; and

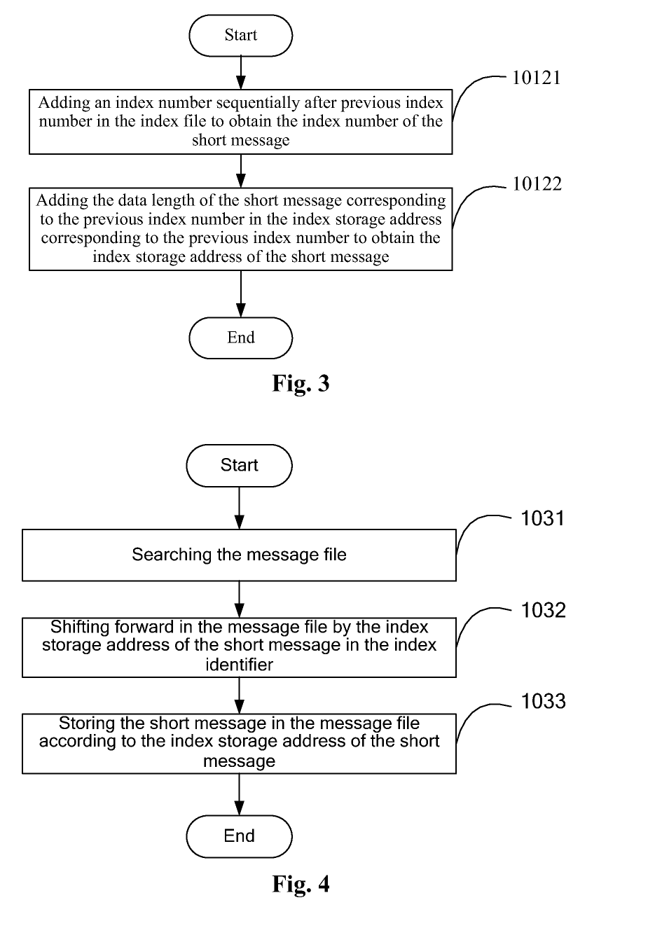

Step 1013: obtaining the data length of the short message. Preferably, as shown in FIG. 3, step 1012 can further comprise:

Step 10121: adding an index number sequentially after the previous index number in the index file to obtain the index number of the short message; and

Step 10122: adding the data length of the short message corresponding to the previous index number in the index storage address corresponding to the previous index number to obtain the index storage address of the short message.

Preferably, as shown in FIG. 4, step 103 can further comprise:

Step 1031: searching the message file;

Step 1032: shifting in the message file to the index storage address of the short message in the index identifier; and

Step 1033: storing the short message in the message file according to the index storage address of the short message.

The process of storing the short message of the embodiment is illustrated below with specific examples.

In order to distinguish from the related EF^{SMS}file, the embodiment names the message file EF_{EXT}_{_{—}}_{SMS}. The file identifier can be, for instance, 6F8C. The storage location of file can be, for instance, in the directory 7F10 too. The file structure of EF_{EXT}_{_{—}}_{SMS} is of transparent type. Size of the file is reasonably set according to the actual capacity of the SIM card. The description herein takes the example of 50 k bytes. The received short messages are stored one by one, according to actual size.

In the embodiment, the index file for storing the index identifier can be named EF_{SMS}_{_{—}}_{INDEX}, and the file identifier can be, for instance, 6F8D. It only needs to be distinguished from all other related files in the SIM card. The storage location of the file can be, for instance, in the directory 7F10 too. In this case, the file structure of EF_{SMS}_{_{—}}_{INDEX} is of linear fixed-length type. Size of the EF_{SMS}_{_{—}}_{INDEX} file is reasonably set according to actual capacity of the SIM card. Each record, namely each index identifier of the EF_{SMS}_{_{—}}_{INDEX} file sequentially comprises three parts: the index number, the index storage address of the short message in the EF_{EXT}_{SMS} file corresponding to the index number, and the data length of the short message corresponding to the index number, namely the data byte length of the short message corresponding to the index number.

It is assumed that there are three index records, namely three index identifiers, in the EF_{SMS}_{_{—}}_{INDEX} file. Storage address of the short message 1 corresponding to the index number 1 starts from 0×0, and byte length of the short message 1 is 0×20 bytes. The short message 2 corresponding to the index number 2 is stored after the short message 1. Storage address of the short message 2 starts from 0×0020, and byte length of the short message 2 is 0×55 bytes. The short message 3 corresponding to the index number 3 is stored after the short message 2. Storage address of the short message 3 starts from 0×0075, and byte length of the short message 3 is 0×32 bytes. The three short messages are correspondingly stored in the EF_{EXT}_{_{—}}_{SMS} file.

When a new short message is received and is to be stored, an index number which is 4 is added in the EF_{SMS}_{_{—}}_{INDEX} file. The newly added short message is named the short message 4. Then, the data length 0×32 of the short message corresponding to the index number 3 is added to the index storage address corresponding to the previous index number, namely storage address 0×0075 of the short message 3 corresponding to the index number 3, to obtain the index storage address 0×0075+0×32=0×0107 corresponding to the index number 4. At the same time, the length of the new short message 4 is recorded in the EF_{SMS}_{_{—}}_{INDEX} file, supposing that length of the short message 4 is 0×16. Then, according to the calculated index storage address 0×0107 of the new short message 4, it shifts in the EF_{EXT}_{_{—}}_{SMS} file to the index storage address. That is, the data content of the new short message 4 is stored from 0×0107.

It should be noted that, the method for processing short message of the embodiment can be compatible with related SIM cards and mobile terminals. In above example, when using related SIM cards and mobile terminals to store the short message, corresponding record number of the corresponding short message in the file 6F3C can be added in the index identifiers of the index file EF_{EXT}_{_{—}}_{SMS}. When the short message 4 is stored in the EF_{EXT}_{_{—}}_{SMS} file successfully, a synchronized mode can be adopted to select a record number which is not occupied in the EF_{SMS} file of the related art to store the short message 4, and the corresponding record number of the EF_{SMS} file is stored in the EF_{EXT}_{_{—}}_{SMS} file. Therefore, the method for storing short message of the embodiment can be used in related SIM cards and mobile terminals, for achieving the purpose of being compatible.

Furthermore, it should be noted that the method of copy of short message performed by the embodiment through mobile terminal is same as the method for storing short message introduced in the embodiment. Thus, no repeated description is given here.

The embodiment stores the short message in storage space of mobile terminal according to the actual data length of the short message, which breaks the limitation in the related art that the short message file is stored according to fixed length. The present solution efficiently utilizes storage space of the SIM card used in mobile terminal, stores as many short messages as possible in limited storage space, improves the utilization ratio of storage space of mobile terminal, saves resources, and provides convenience for manufactures and users of mobile terminals. Furthermore, the method for processing short message of the embodiment can be compatible with related SIM cards and mobile terminals, and related SIM cards and mobile terminals can still perform processes, such as storage of short messages, using the 6F3C file structure as usual.

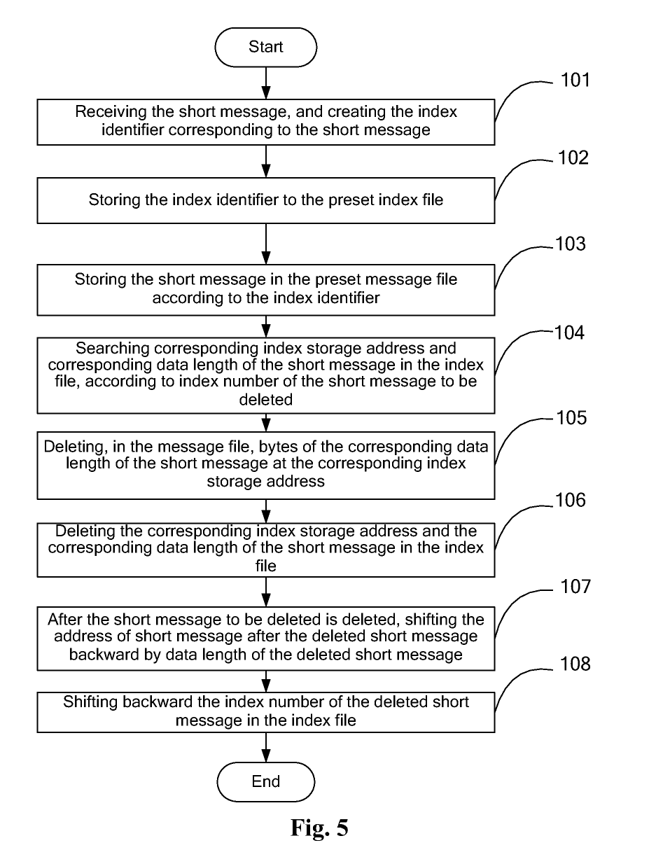

As shown in FIG. 5, another embodiment of the disclosure provides a method for processing short message. Based on the above embodiment, after step 103, the method can further comprise:

Step 104: searching for the corresponding index storage address and the data length of the corresponding short message in the index file, according to the index number of the short message to be deleted;

Step 105: deleting, from the message file, bytes of the data length of the corresponding short message at the corresponding index storage address;

Step 106: deleting the corresponding index storage address and the data length of the corresponding short message from the index file;

Step 107: after the short message to be deleted is deleted, shifting the address of short message after the deleted short message backward by the data length of the deleted short message; and

Step 108: shifting backward the index number of the deleted short message in the index file.

The embodiment stores the short message in storage space of mobile terminal according to the actual data length of the short message. Based on that, the embodiment can perform process of deletion of the short message. This solution breaks the limitation in the related art that the short message file is stored according to fixed length, efficiently utilizes storage space of the SIM card used in mobile terminal, stores as many short messages as possible in limited storage space, improves the utilization ratio of storage space of mobile terminal, saves resources, and provides convenience for manufactures and users of mobile terminals. Furthermore, the method for processing short message of the embodiment can be compatible with related SIM cards and mobile terminals, and related SIM cards and mobile terminals can still perform processes, such as storage of short message, using the 6F3C file structure as usual.

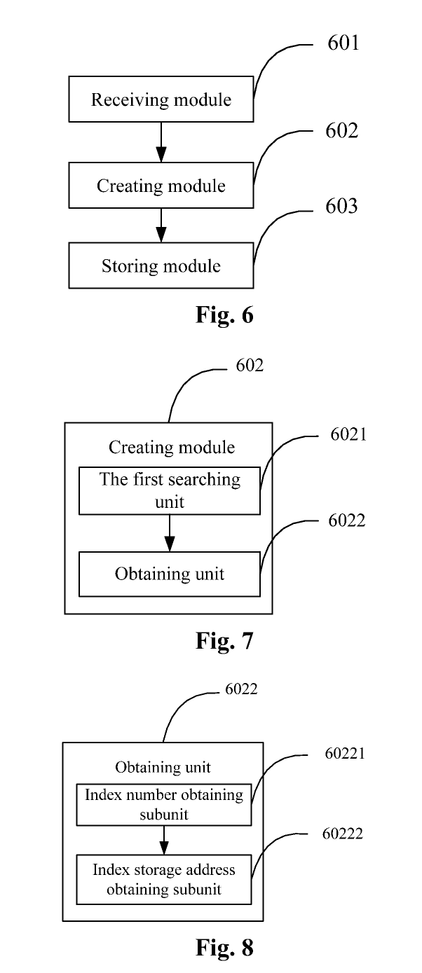

As shown in FIG. 6, an embodiment of the disclosure provides a terminal for processing short message, which can comprise:

a receiving module 601, configured to receive the short message;

a creating module 602, configured to create the index identifier corresponding to the short message; and

a storing module 603, configured to store the index identifier in the preset index file, and store the short message in the preset message file according to the index identifier.

Preferably, as shown in FIG. 7, the creating module 602 can further comprise:

a first searching unit 6021, configured to search the index file; and

an obtaining unit 6022, configured to obtain the index number of the short message and the index storage address of the short message according to the index file, and obtain the data length of the short message.

Preferably, as shown in FIG. 8, the obtaining unit 6022 can further comprise:

an index number obtaining subunit 60221, configured to sequentially add an index number after the previous index number in the index file to obtain the index number of the short message; and

an index storage address obtaining subunit 60222, configured to add the data length of the short message corresponding to the previous index number in the index storage address corresponding to the previous index number to obtain the index storage address of the short message.

Preferably, as shown in FIG. 9, the storing module 603 can further comprise:

a second searching unit 6031, configured to search the message file;

a shifting subunit 6032, configured to shift in the message file to the index storage address of the short message in the index identifier; and

a storing subunit 6033, configured to store the short message in the message file according to the index storage address of the short message.

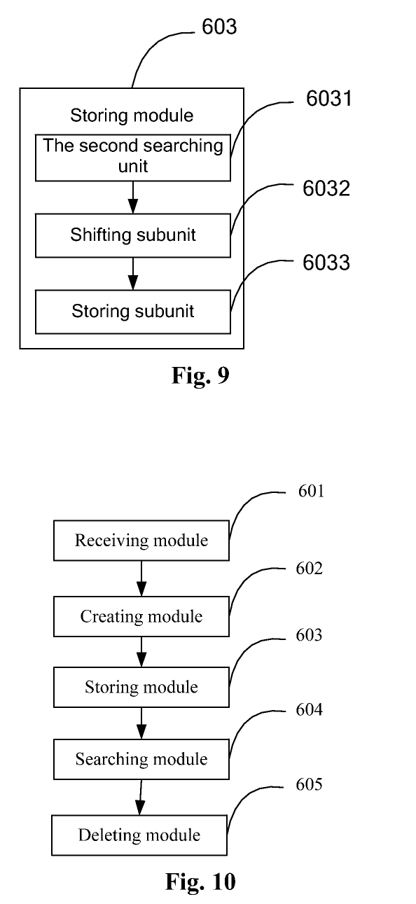

Preferably, as shown in FIG. 10, another embodiment of the disclosure provides a terminal for processing short message. Based on above embodiment, the terminal can further comprise:

a searching module 604, configured to search for the corresponding index storage address and the data length of the corresponding short message in the index file, according to the index number of the short message to be deleted; and

a deleting module 605, configured to delete, from the message file, bytes of the data length of the corresponding short message at the corresponding index storage address, and delete the corresponding index storage address and the data length of the corresponding short message from the index file.

Furthermore, the shifting subunit 6032 is further configured to, after the short message to be deleted is deleted, shift addresses of short messages after the deleted short message backward by the data length of the deleted short message, and shift backward the index number of the deleted short message in the index file.

It should be noted that the terminal of the embodiment can be the intelligent subscriber identity card with functions of storing short message, comprising SIM card, UIM card, USIM card or PIM card and so on.

The embodiment of the disclosure performs processes, such as storage, deletion and copy, to the short message in storage space of mobile terminal according to the actual data length of the short message, and stores as many short messages as possible in limited storage space. Thereby, this solution breaks the limitation in the related art that the short message file is stored according to fixed length, efficiently utilizes storage space of the SIM card used in mobile terminal, stores as many short messages as possible in limited storage space, improves the utilization ratio of storage space of mobile terminal, saving resources, and provides convenience for manufactures and users of mobile terminals. Furthermore, the method for processing short message of the embodiment can be compatible with related SIM cards and mobile terminals, and related SIM cards and mobile terminals can still perform processes, such as storage, deletion and copy, to the short message using the 6F3C file structure as usual.

The above is only the preferred embodiments of the disclosure and not intended to limit the scope of the claims of the disclosure. Any equivalent replacements of structure or flow based on the contents of the specification and the drawings of the disclosure, and any direct or indirect application of the disclosure in other related technical fields shall fall within the scope of the claims of the disclosure.

1. A method for processing short message, comprising:
receiving a short message, and creating an index identifier corresponding to the short message;
storing the index identifier in a preset index file; and
storing the short message in a preset message file according to the index identifier.

2. The method according to claim 1, wherein
the index identifier comprises: an index number, an index storage address corresponding to the index number and a data length of a short message corresponding to the index number.

3. The method according to claim 1 or 2, wherein the step of creating the index identifier corresponding to the short message comprises:
searching the index file;
obtaining an index number of the short message and an index storage address of the short message according to the index file; and
obtaining a data length of the short message.

4. The method according to claim 3, wherein the step of obtaining the index number of the short message and the index storage address of the short message according to the index file comprises:
adding an index number sequentially after a previous index number in the index file to obtain the index number of the short message; and
adding a data length of a short message corresponding to the previous index number to an index storage address corresponding to the previous index number to obtain the index storage address of the short message.

5. The method according to claim 4, wherein the step of storing the short message in the preset message file according to the index identifier comprises:
searching the message file;
shifting in the message file to the index storage address of the short message in the index identifier; and
storing the short message in the message file according to the index storage address of the short message.

6. The method according to claim 4, wherein after the step of storing the short message in the preset message file according to the index identifier, the method further comprises:
searching, according to an index number of a short message to be deleted, for a corresponding index storage address and a data length of the corresponding short message in the index file;
deleting, from the message file, bytes of the data length of the corresponding short message at the corresponding index storage address; and
deleting, from the index file, the corresponding index storage address and the data length of the corresponding short message.

7. The method according to claim 6, wherein after the step of deleting from the index file the corresponding index storage address and the data length of the corresponding short message, the method further comprises:
after the short message to be deleted is deleted, shifting an address of a short message after the deleted short message backward by the data length of the deleted short message;
shifting backward the index number of the deleted short message in the index file.

8. A terminal for processing short message, comprising:
a receiving module, configured to receive a short message;
a creating module, configured to create an index identifier corresponding to the short message; and
a storing module, configured to store the index identifier in a preset index file, and store the short message in a preset message file according to the index identifier.

9. The terminal according to claim 8, wherein the creating module comprises:
a first searching unit, configured to search the index file; and
an obtaining unit, configured to obtain an index number of the short message and an index storage address of the short message according to the index file, and obtain a data length of the short message.

10. The terminal according to claim 9, wherein the obtaining unit comprises:
an index number obtaining subunit, configured to sequentially add an index number after a previous index number in the index file to obtain the index number of the short message; and
an index storage address obtaining subunit, configured to add a data length of a short message corresponding to the previous index number to an index storage address corresponding to the previous index number to obtain the index storage address of the short message.

11. The terminal according to claim 8, 9 or 10, wherein the storing module comprises:
a second searching unit, configured to search the message file;
an shifting subunit, configured to shift in the message file to the index storage address of the short message in the index identifier; and
a storing subunit, configured to store the short message in the message file according to the index storage address of the short message.

12. The terminal according to claim 11, further comprising:
a searching module, configured to search, according to an index number of a short message to be deleted, for a corresponding index storage address and a data length of the corresponding short message in the index file,; and
a deleting module, configured to delete, from the message file, bytes of the data length of the corresponding short message at the corresponding index storage address, and delete the corresponding index storage address and the data length of corresponding the short message from the index file.

13. The terminal according to claim 12, wherein
the shifting subunit is further configured to, after the short message to be deleted is deleted, shift an address of a short message after the deleted short message backward by the data length of the deleted short message, and shift backward the index number of the deleted short message in the index file.

14. The method according to claim 2, wherein the step of creating the index identifier corresponding to the short message comprises:
searching the index file;
obtaining an index number of the short message and an index storage address of the short message according to the index file; and
obtaining a data length of the short message.

15. The method according to claim 14, wherein the step of obtaining the index number of the short message and the index storage address of the short message according to the index file comprises:
adding an index number sequentially after a previous index number in the index file to obtain the index number of the short message; and
adding a data length of a short message corresponding to the previous index number to an index storage address corresponding to the previous index number to obtain the index storage address of the short message.

16. The method according to claim 15, wherein the step of storing the short message in the preset message file according to the index identifier comprises:
searching the message file;
shifting in the message file to the index storage address of the short message in the index identifier; and
storing the short message in the message file according to the index storage address of the short message.

17. The method according to claim 15, wherein after the step of storing the short message in the preset message file according to the index identifier, the method further comprises:
searching, according to an index number of a short message to be deleted, for a corresponding index storage address and a data length of the corresponding short message in the index file;
deleting, from the message file, bytes of the data length of the corresponding short message at the corresponding index storage address; and
deleting, from the index file, the corresponding index storage address and the data length of the corresponding short message.

18. The method according to claim 5, wherein after the step of storing the short message in the preset message file according to the index identifier, the method further comprises:
searching, according to an index number of a short message to be deleted, for a corresponding index storage address and a data length of the corresponding short message in the index file;
deleting, from the message file, bytes of the data length of the corresponding short message at the corresponding index storage address; and
deleting, from the index file, the corresponding index storage address and the data length of the corresponding short message.

19. The terminal according to claim 9, wherein the storing module comprises:
a second searching unit, configured to search the message file;
an shifting subunit, configured to shift in the message file to the index storage address of the short message in the index identifier; and
a storing subunit, configured to store the short message in the message file according to the index storage address of the short message.

20. The terminal according to claim 10, wherein the storing module comprises:
a second searching unit, configured to search the message file;
an shifting subunit, configured to shift in the message file to the index storage address of the short message in the index identifier; and
a storing subunit, configured to store the short message in the message file according to the index storage address of the short message.
